(19) United States
(12) Patent Application Publication
(10) Pub. No.: US 2018/0079639 A1
(43) Pub. Date: Mar. 22, 2018

(54) Gas Pump Handle Holding Device

(71) Applicant: Graham Byrne, South San Francisco, CA (US)

(72) Inventor: Graham Byrne, South San Francisco, CA (US)

(21) Appl. No.: 15/272,030

(22) Filed: Sep. 21, 2016

(51) Int. Cl. B67D 7/42; F16B 2/10

(52) U.S. Cl. CPC B67D 7/42; B67D 7/04; F16B 2/10

(57) ABSTRACT

A gas pump handle holding device for preventing transfer of odors and germs from the handle to the hand of the user includes a biaser, a pair of grasps, and a pair of clamps. Each grasp has a lower section that is coupled to the biaser. The grasps are positioned on the biaser such that the biaser orients the grasps to an open disposition. Each clamp is coupled to and extends from proximate to a bottom edge of a lower section of a respective grasp. The clamps are positioned on the grasps such that the grasps are configured to squeeze in a hand of the user to reversibly motivate the clamps from a closed configuration to an open configuration. The clamps are positionable around and couplable to a handle of a gas pump, such that odors and germs on the handle are not transferred to the hand of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to holding devices and more particularly pertains to a new holding device for preventing transfer of odors and germs from the handle to the hand of the user.

### BRIEF SUMMARY OF THE INVENTION

An embodiment of the disclosure meets the needs presented above by generally comprising a biaser, a pair of grasps, and a pair of clamps. Each grasp has a lower section that is coupled to the biaser. The grasps are positioned on the biaser such that the biaser orients the grasps to an open disposition. Each clamp is coupled to and extends from proximate to a bottom edge of a lower section of a respective grasp. The clamps are positioned on the grasps such that the grasps are configured to squeeze in a hand of the user to reversibly motivate the clamps from a closed configuration to an open configuration. The clamps are positionable around and couplable to a handle of a gas pump, such that odors and germs on the handle are not transferred to the hand of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a gas pump handle holding device according to an embodiment of the disclosure.

FIG. 2 is a top view of an embodiment of the disclosure.

FIG. 3 is an end view of an embodiment of the disclosure.

FIG. 4 is an end view of an embodiment of the disclosure.

FIG. 5 is a side view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

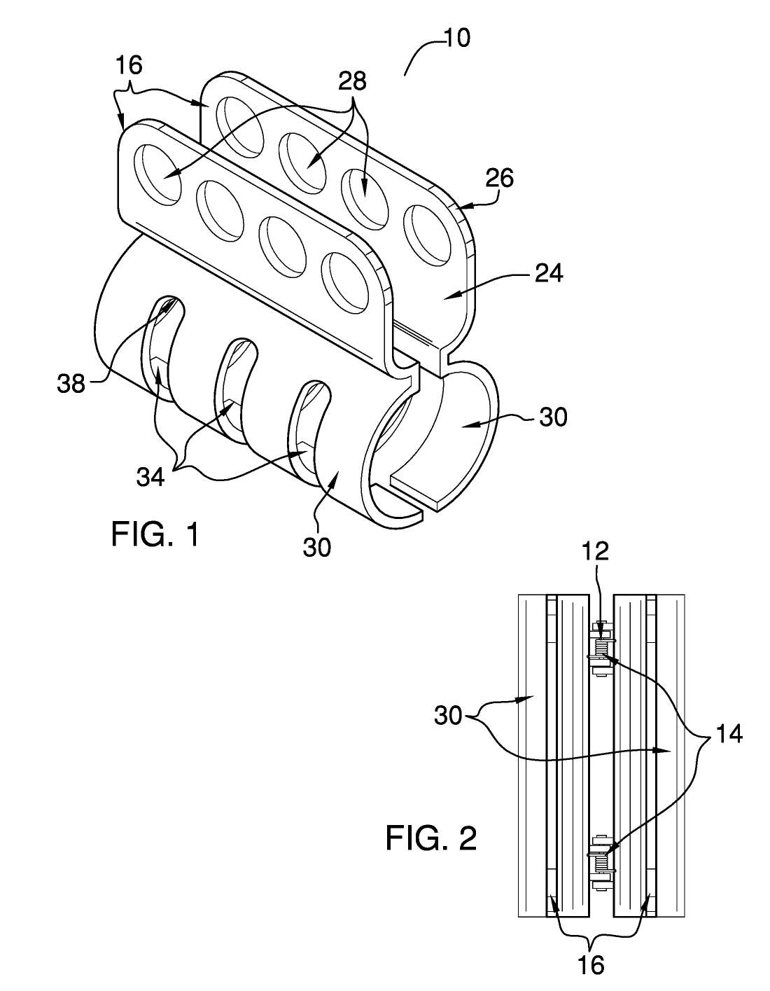

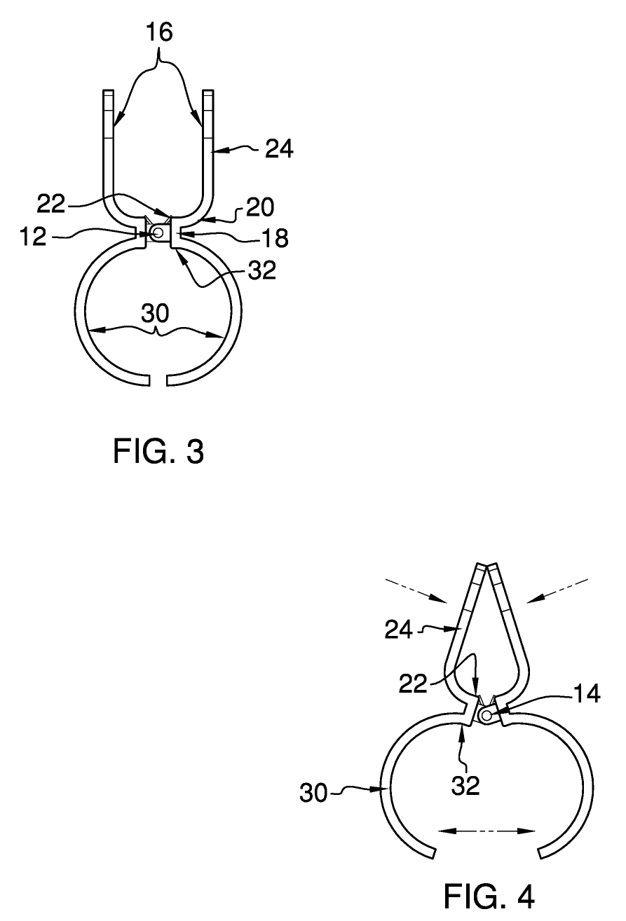

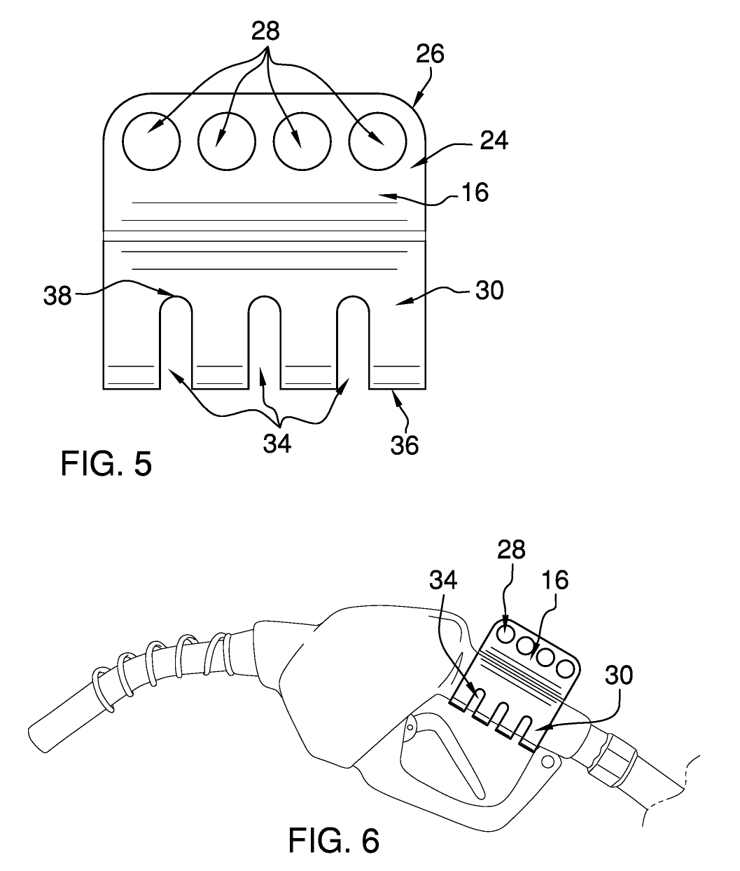

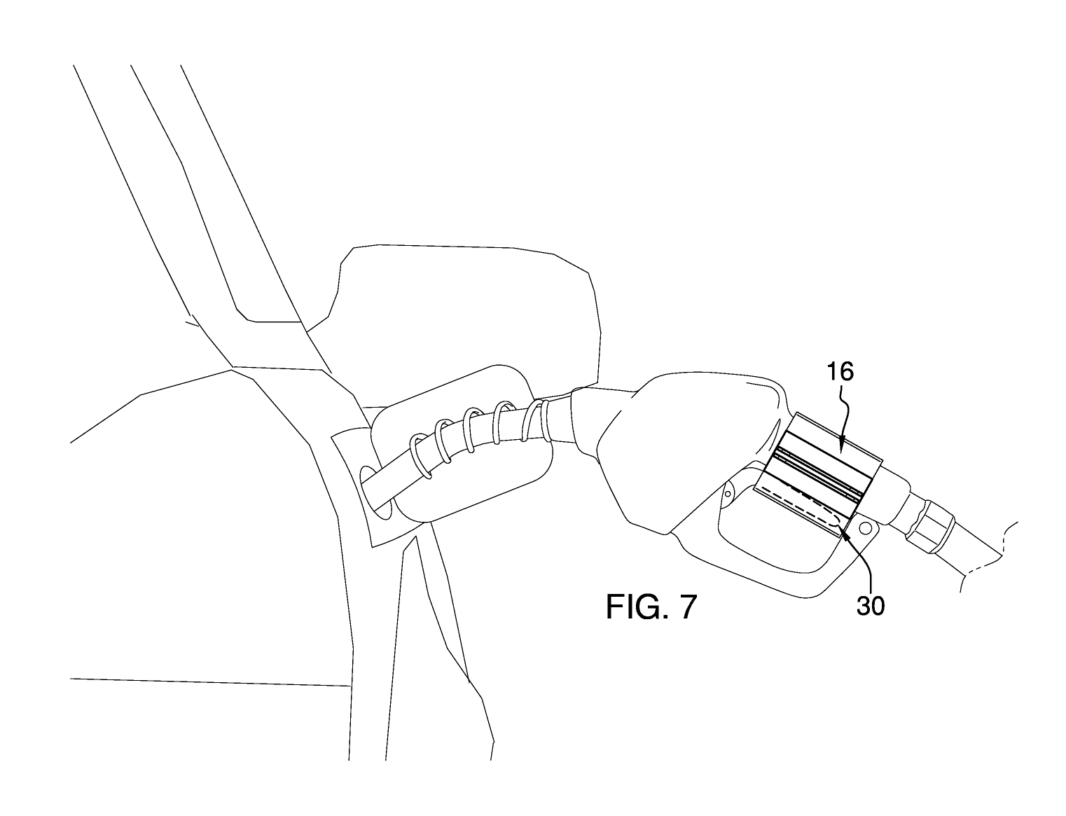

With reference now to the drawings, and in particular to FIGS. 1 through 7 thereof, a new holding device embodying the principles and concepts of an embodiment of the disclosure and generally designated by the reference numeral 10 will be described.

As best illustrated in FIGS. 1 through 7, the gas pump handle holding device 10 generally comprises a biaser 12. In one embodiment, the biaser 12 comprises a plurality of springs 14. In another embodiment, the plurality of springs 14 comprises two springs 14.

Each of a pair of grasps 16 has a lower section 18. The lower sections 18 are coupled to the biaser 12. The grasps 16 are positioned on the biaser 12 such that the biaser 12 orients the grasps 16 to an open disposition. Each grasp 16 comprises a middle section 20 that is coupled to and extends arcuately from a top edge 22 of the lower section 18. A top section 24 is coupled to and extends from the middle section 20 distal from the lower section 18. The top sections 24 have upper corners 26. In one embodiment, the upper corners 26 are rounded. The top sections 24 of the grasps 16 are substantially parallel planarly is positioned when the grasps 16 are in the open disposition.

In one embodiment, a plurality of holes 28 is positioned through the top sections 24 of the grasps 16. The holes 28 are positioned in the top sections 24 such that the holes 28 are configured to insert digits of a hand of a user. In another embodiment, the holes 28 are substantially evenly spaced. In yet another embodiment, the plurality of holes 28 comprises eight holes 28 distributed evenly in the top sections 24.

Each of a pair of clamps 30 is coupled to and extends from proximate to a bottom edge 32 of the lower section 18 of a respective grasp 16. The clamps 30 are positioned on the grasps 16 such that the grasps 16 are configured to squeeze in the hand of the user to reversibly motivate the clamps 30 from a closed configuration to an open configuration. The clamps 30 are positionable around and couplable to a handle of a gas pump. In one embodiment, the clamps 30 are arcuate.

In one embodiment, a plurality of slots 34 is positioned through the clamps 30. Each slot 34 extends from a lower edge 36 of a respective clamp 30. Each slot 34 has an upper rim 38. In another embodiment, the upper rim 38 is rounded. In yet another embodiment, the slots 34 are substantially evenly spaced. In still yet another embodiment, the plurality of slots 34 comprises six slots 34 distributed evenly in the clamps 30.

In use, the holes 28 positioned in the top sections 24 are configured to insert digits of a hand of a user. The grasps 16 are configured to squeeze in the hand of the user to reversibly motivate the clamps 30 from a closed configuration to an open configuration. The clamps 30 are positionable around and couplable to a handle of a gas pump. Odors and germs on the handle are not transferred to the hand of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gas pump handle holding device comprising:
a biaser;
a pair of grasps, each said grasp having a lower section, said lower section being coupled to said biaser, wherein said grasps are positioned on said biaser such that said biaser orients said grasps to an open disposition;
a pair of clamps, each said clamp being coupled to and extending from proximate to a bottom edge of a said lower section of a respective said grasp; and
wherein said clamps are positioned on said grasps such that said grasps are configured for squeezing in a hand of the user to reversibly motivate said clamps from a closed configuration to an open configuration, such that said clamps are positionable around and couplable to a handle of a gas pump, such that odors and germs on the handle are not transferred to the hand of the user.

2. The device of claim 1, further including said biaser comprising a plurality of springs.

3. The device of claim 2, further including said plurality of springs comprising two said springs.

4. The device of claim 1, further including each said grasp comprising:
a middle section coupled to and extending arcuately from a top edge of said lower section;
a top section coupled to and extending from said middle section distal from said lower section; and
wherein said top sections of said grasps are substantially parallel planarly positioned when said grasps are in the open disposition.

5. The device of claim 4, further including said top sections having upper corners, said upper corners being rounded.

6. The device of claim 4, further including a plurality of holes positioned through said top sections of said grasps, wherein said holes are positioned in said top sections such that said holes are configured for insertion of digits of a hand of a user.

7. The device of claim 6, further including said holes being substantially evenly spaced.

8. The device of claim 6, further including said plurality of holes comprising eight said holes distributed evenly in said top sections.

9. The device of claim 1, further including said clamps being arcuate.

10. The device of claim 1, further including a plurality of slots positioned through said clamps, each said slot extending from a lower edge of a respective said clamp.

11. The device of claim 10, further including each said slot having an upper rim, said upper rim being rounded.

12. The device of claim 10, further including said slots being substantially evenly spaced.

13. The device of claim 10, further including said plurality of slots comprising six said slots distributed evenly in said clamps.

14. A gas pump handle holding device comprising:
a biaser, said biaser comprising a plurality of springs, said plurality of springs comprising two said springs;
a pair of grasps, each said grasp having a lower section, said lower section being coupled to said biaser, wherein said grasps are positioned on said biaser such that said biaser orients said grasps to an open disposition, each said grasp comprising:
a middle section coupled to and extending arcuately from a top edge of said lower section,
a top section coupled to and extending from said middle section distal from said lower section, said top sections having upper corners, said upper corners being rounded, and
wherein said top sections of said grasps are substantially parallel planarly positioned when said grasps are in the open disposition;
a plurality of holes positioned through said top sections of said grasps, wherein said holes are positioned in said top sections such that said holes are configured for insertion of digits of a hand of a user, said holes being substantially evenly spaced, said plurality of holes comprising eight said holes distributed evenly in said top sections;
a pair of clamps, each said clamp being coupled to and extending from proximate to a bottom edge of a said lower section of a respective said grasp, wherein said clamps are positioned on said grasps such that said grasps are configured for squeezing in a hand of the user to reversibly motivate said clamps from a closed configuration to an open configuration, such that said clamps are positionable around and couplable to a handle of a gas pump, said clamps being arcuate;
a plurality of slots positioned through said clamps, each said slot extending from a lower edge of a respective said clamp, each said slot having an upper rim, said upper rim being rounded, said slots being substantially evenly spaced, said plurality of slots comprising six said slots distributed evenly in said clamps; and
wherein said holes are positioned in said top sections such that said holes are configured for insertion of digits of a hand of a user, wherein said clamps are positioned on said grasps such that said grasps are configured for squeezing in the hand of the user to reversibly motivate said clamps from a closed configuration to an open configuration, such that said clamps are positionable around and couplable to a handle of a gas pump, such that odors and germs on the handle are not transferred to the hand of the user.
